(19) United States
(12) Patent Application Publication
(10) Pub. No.: US 2026/0280795 A1
(43) Pub. Date: Sep. 17, 2026

(54) METHOD FOR PHASE TRACKING REFERENCE SIGNAL TRANSMISSION FOR UPLINK MULTI-CODEWORD BASED OPERATION

(71) Applicant: Google LLC, MOUNTAIN VIEW, CA (US)

(72) Inventors: Yushu ZHANG, Beijing (CN); Jia-Hong LIOU, Taipei (TW)

(21) Appl. No.: 19/166,596

(22) PCT Filed: Mar. 31, 2023
(86) PCT No.: PCT/CN2023/085401

§ 371 Date: Sep. 18, 2025

(51) Int. Cl. H04L 5/00; H04L 1/00; H04W 72/21

(52) U.S. Cl. CPC H04L 5/0048; H04L 1/0003; H04L 1/0009; H04W 72/21

(57) ABSTRACT

Methods and devices in a wireless network determine one or more of a number of phase tracking reference signals, PT-RS, a time-domain density thereof and PT-RS associated port(s). Control signaling for configuring a multi-codeword transmission of at least one PT-RS is transmitted from a network entity to a UE and includes parameters for identifying one or more ports to be used by the UE for transmitting the PT-RS.

### FIELD OF THE DISCLOSURE

This document generally describes methods and devices operating in wireless communication systems such as (but not limited to) the ones described in 5G standard documents, known as 3GPP communication systems.

### BACKGROUND

A 5G user equipment (UE), which is a device allowing a user's access to network services, as described in current standard documents is configurable to transmit a phase tracking reference signal (PT-RS) associated with a physical uplink shared channel (PUSCH) to enable phase tracking and compensation of received PUSCH data for the symbols without demodulation reference signal (DMRS). The UE can transmit the PT-RS from one port or two ports. The two PT-RS ports are multiplexed in a frequency division multiplexing (FDM) manner. The UE may transmit the PT-RS from one port in every L symbol(s), where L (known as time domain density) is determined based on the scheduled modulation and coding scheme (MCS). FIG. 1 illustrates one example transmission block including PT-RS transmitted with a time domain density L=2. In this example, PT-RS is transmitted every other symbol using the same subcarrier except for the symbol in which DMRSs are transmitted using multiple subcarriers.

The UE transmits data from more than four transmission layers using two codewords. The number of layers indicates the number of columns for the precoder applied for the PUSCH transmission.

The NE may indicate the MCS for the PUSCH via Downlink Control Information, DCI, or via Radio Resource Control, RRC, signaling for an initial transmission. Currently, for dynamic-grant PUSCH or Type2 configured-grant PUSCH, the NE indicates the MCS via DCI, and for Type1 configured-grant PUSCH, the NE configures the MCS via RRC signaling. In case of a retransmission, the NE may indicate the same MCS or indicate a reserved MCS via DCI. The reserved MCS indicates the MCS above an MCS threshold V (e.g., V=28 or 27 depending on other parameters as shown in tables of section 5.1.3.1 of 3GPP TS 38.214). The reserved MCS only indicates the modulation order. UE transmits the transport block (TB) as the initially transmitted based on the modulation order indicated by the reserved MCS. Some features related to PT-RS are described in section 6.4.1.2 (which defines sequence generation and resource mapping for PT-RS) of 3GPP TS 38.211 and section 6.2.3 (that describes procedures for PT-RS transmission) of 3GPP TS 38.214.

A network entity, NE, configures the MCS threshold for the UE to identify the value of the time domain density L. The NE may be a base station, BS, but it is more generally a logically separate entity with a well-defined functionality (e.g., BS's functionality is connecting UEs to the core network). The presence of the PT-RS is also determined based on the scheduled MCS.

Selecting the best precoder/channel/antenna port for transmitting the PT-RS and determining the PT-RS time domain density may be challenging when one of the codewords is disabled, as illustrated in FIG. 2, or it is associated with a reserved MCS, as illustrated in FIG. 3.

Another conventionally unresolved issue is indicating ports for transmitting more than one (e.g., two) PT-RS in multi-codeword based operation.

### SUMMARY

Methods performed by UE and NE embody techniques for UE transmitting one or more PT-RS for uplink multi-codeword based operation. A UE and a network entity, NE, are endpoints of a multi-codeword transmission including one or more PT-RSs. A control signaling including parameters is transferred there-between for configuring a multi-codeword transmission. The UE and the NE may determine a number of ports to be used by the UE for the at least one PT-RS based on values and indications included in the parameters. The UE and the NE may identify the ports to be used by the UE to transmit the PT-RS among ports used alternatively to transmit demodulation reference signals, DMRS. The UE and the NE may also determine a time domain density for the transmitting of the PT-RS and the PT-RS ports based on the MCSs associated with the codewords and by applying additional rules if a codeword initially selected for transmitting the PT-RS is disabled or its MCS is a reserved MCS. The UE then transmits, to the NE, data and at least one PT-RS via at least two codewords, according to the configured multi-codeword transmission and employing the one or more ports identified according to the parameters.

### BRIEF DESCRIPTION OF THE DRAWINGS

The accompanying drawings, which are incorporated in and constitute a part of the specification, illustrate one or more embodiments and, together with the description, explain these embodiments.

FIG. 1 illustrates one example transmission block including PT-RS.

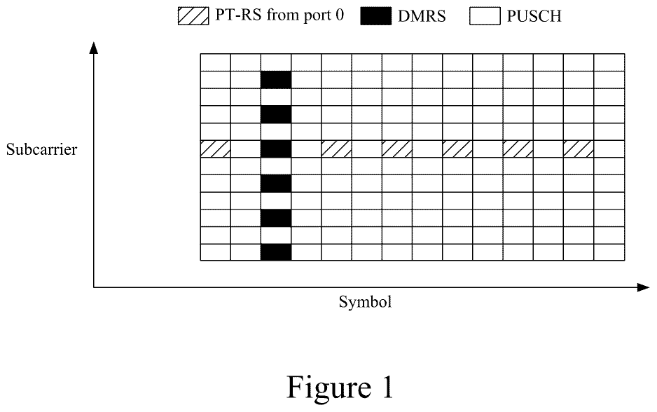

FIG. 2 schematically illustrates a first scenario in which conventional approach fails.

FIG. 3 schematically illustrates a second scenario in which conventional approach fails.

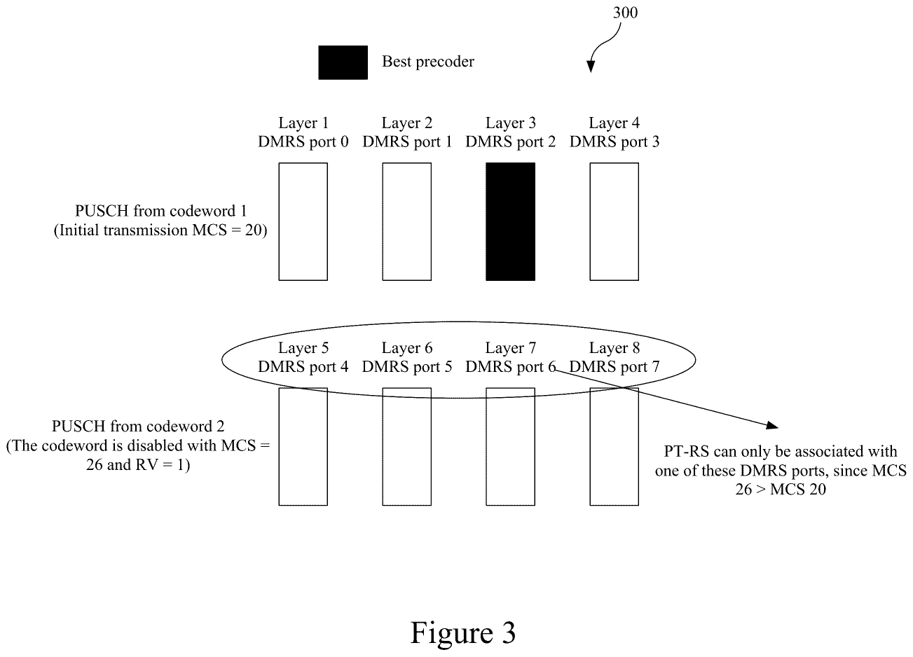

FIG. 4 is a diagram of a wireless system with devices implementing PT-RS transmission for uplink multi-codeword based operation according to various embodiments.

FIG. 5 is a signal diagram for a PT-RS transmission for uplink multi-codeword based operation according to an embodiment.

FIG. 6 is a flowchart illustrating UE behavior for PT-RS transmission for PUSCH with more than one codewords according to an embodiment.

FIG. 7 illustrates NE's behavior for PT-RS reception for PUSCH with more than one codewords according to an embodiment.

FIG. 8 illustrates a scenario for the PT-RS and DMRS port association based on the enabled codeword only according to an embodiment.

FIG. 9 illustrates a scenario in which PT-RS is disabled when associated with a DMRS port corresponding to a disabled codeword according to an embodiment.

FIG. 10 illustrates a scenario related to determining the PT-RS time domain density based on the MCS from the enabled codeword if PT-RS is associated with a DMRS port corresponding to a disabled codeword according to an embodiment.

FIG. 11 illustrates a scenario related to determining the PT-RS time domain density based on the MCS from the disabled codeword if PT-RS is associated with a DMRS port corresponding to a disabled codeword according to an embodiment.

FIG. 12 illustrates a scenario related to determining PT-RS time domain density, and PT-RS associated DMRS port based on the MCS for initial transmission when one of the indicated MCS is reserved MCS according to an embodiment.

FIG. 13 illustrates a scenario in which PT-RS associated DMRS port and the time domain density for a PT-RS port are based on nominal MCS when one of the indicated MCS is reserved MCS according to an embodiment.

FIG. 14 illustrates a scenario in which PT-RS time domain density is determined based on the MCS for initial transmission when one of the indicated MCS is reserved MCS.

FIG. 15 illustrates a scenario for determining the PT-RS time domain density based on the nominal MCS when the MCS for the codeword corresponding to PT-RS associated DMRS port is a reserved MCS according to an embodiment.

FIG. 16 illustrates a scenario for indicating PT-RS associated DMRS port with limited overhead in DCI according to an embodiment.

FIG. 17 is a flowchart of a method for transmitting PT-RS in a multi-codeword based operation according to an embodiment.

### DETAILED DESCRIPTION

Methods and devices described in this section embody techniques related to PT-RS for uplink multi-codeword based operation. More specifically some embodiments determine a number of PT-RS ports and antenna ports to be used for PT-RS for both an initial transmission and a retransmission. Some embodiments determine time density for the PT-RS ports when a codeword is disabled or is associated with a reserved MCS. These embodiments of techniques for PT-RS transmission based on uplink multi-codeword operation yield the PT-RS being transmitted on DMRS antenna ports associated with a better precoder, which can improve the performance for the PUSCH. The time domain density determination for the PT-RS according to some embodiments identify the best PT-RS density corresponding to the two (or more) codewords PUSCH, which can reduce the PT-RS overhead and improve the performance for the PUSCH with two codeword transmission.

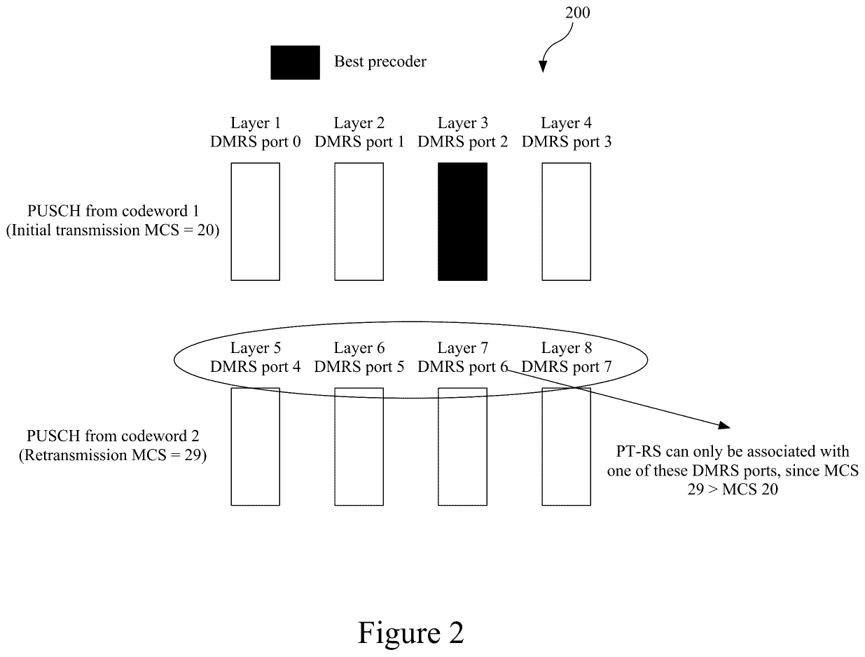

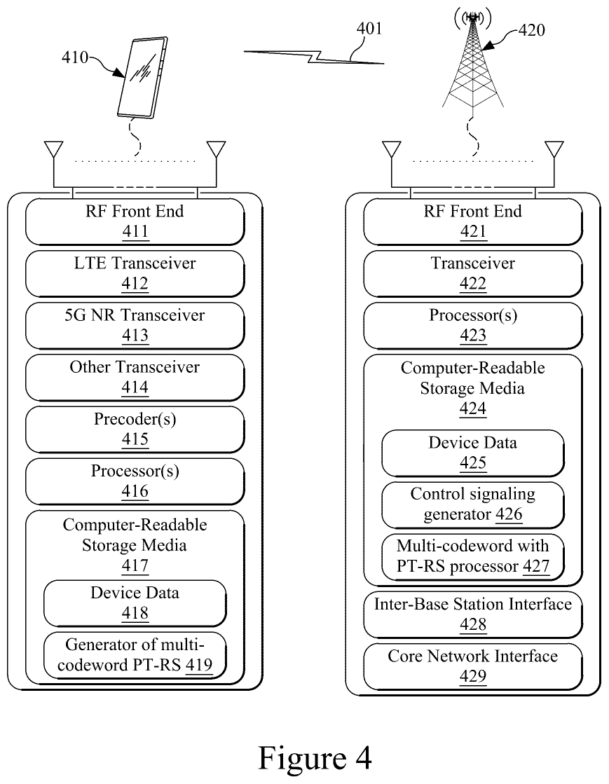

FIG. 4 depicts a wireless communication system 400 including UE 410 and network entity, NE, 420, that can implement various techniques related to PT-RS transmission for uplink multi-codeword based transmission according to embodiments. A NE may be a base station, BS, but more generally, the term stands for a wireless device with a well-defined network functionality (e.g., BS's functionality is connecting UEs to the core network including managing communications to and from the UEs). UE 410 and NE 420 may include additional functions and interfaces omitted from FIG. 2 in the interest of brevity. Signaling arrow 401 generally represents both uplink and downlink signals transmitted by UE 410 and NE 420, respectively.

UE 410 includes antennas connected to a radio frequency (RF) front end 411, and at least one RF transceiver (such as, an LTE transceiver 412, a 5G NR transceiver 413, or another transceiver 414) for communicating with NE 420. The antennas and the RF front end 411 can be tuned to one or more frequency bands (e.g., subcarriers), for example, as defined by 3GPP LTE, 5G NR, and 6G communication standards and implemented by respective transceivers. UE 410 also includes one or more precoders 415, one or more processor(s) 416, and computer-readable storage media (CRM) 417. Processor(s) 416 may be single or multiple-core processors, and CRM 417 includes any suitable memory/storage other than propagating signals. For example, memory/storage can include random-access memory (RAM), static RAM (SRAM), dynamic RAM (DRAM), non-volatile RAM (NVRAM), read-only memory (ROM), and/or flash memory useable to store device data 418 and generator of multi-codeword PT-RS 419 implementing various techniques described in this document. Device data 418 stores instructions executable by processor(s) 416 to facilitate user-plane communication, control-plane signaling and user interaction for UE 410. The generator of multi-codeword PT-RS 419, which may be implemented not only as software but also as hardware logic and/or circuitry, causes various steps and actions associated with PT-RS transmission for multi-codeword based operation.

NE 420 as illustrated in FIG. 4 provides functionality of a gNB (5G or 6G base station). NE 420's functionality may be distributed across multiple entities (e.g., a central unit, CU, a distributed unit, DU, and a radio unit, RU). NE 420 includes antennas and an RF front end 421 and RF transceiver(s) 422 (there may be more transceivers for different technologies, as illustrated for UE 410) for communicating with UE 410 and other NEs. NE's antennas and RF front end 421 can be tuned to one or more frequency bands (e.g., subcarriers), for example as defined by 3GPP LTE, 5G NR, and 6G communication standards and implemented by RF transceiver(s) 422.

NE 420 includes processor(s) 423 and computer-readable storage media (CRM) 424. Processor(s) 423 can include single or multiple-core processors, and CRM 424 includes any suitable memory/storage except propagating signals. For example, memory/storage can include random-access memory (RAM), static RAM (SRAM), dynamic RAM (DRAM), non-volatile RAM (NVRAM), read-only memory (ROM), and/or flash memory. CRM 424 stores device data 425, which includes network scheduling data, radio resource management data, applications, and/or an operating system, which are executable by processor(s) 423 to enable wireless communication 401 with UE 410 as well as with other NEs.

CRM 424 also stores control signal generator 426 and multi-codeword with PT-RS processor 427. NE's control signaling generator 426 causes NE to perform various steps and actions associated with configuring the UE for a multi-codeword transmission including PT-RS. Multi-codeword with PT-RS processor 427 processes the multi-codeword transmission including PT-RS received from UE 410.

NE 420 also includes inter-base station interface 428 and core-network interface 429. Inter-base station interface 428 can be a standardized interface, such as an Xn and/or X2 interface, for exchanging user-plane and control-plane data with another NE (e.g., in case of a handover). Core-network interface 429 enables NE's user-plane data and control-plane information exchange with core network functions and/or entities.

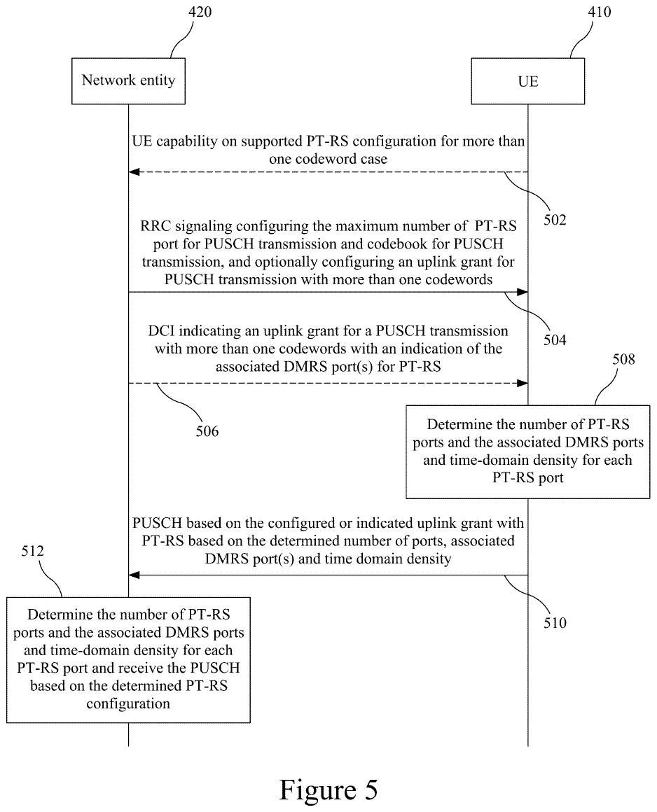

A wireless system such as the one schematically illustrated in FIG. 4 may implement various techniques related to PT-RS transmission for uplink multi-codeword based operation as further described. FIG. 5 is a signaling diagram (with time flowing from top to bottom) of such techniques for PT-RS transmission and reception for PUSCH with more than one codewords.

UE reports 502 its capability related to supported PT-RS configuration(s) for PUSCH with multiple codewords transmission to the UE. However, signaling 502 is optional (as suggested by the dashed line) because the NE may alternatively receive the one or more capabilities from a core network (e.g., Access and Mobility Management Function (AMF)). Yet in some embodiments, the NE receives the one or more capabilities from another NE (e.g., gNB or eNB).

Based on the UE capability, NE 420 transmits 504 an RRC signaling configuring the maximum number of PT-RS ports and codebook for PUSCH transmission. The NE may configure the PUSCH transmission based on cyclic prefix orthogonal frequency division multiplexing (CP-OFDM) waveform and thus, it may disable the transform precoding. For a configured-grant PUSCH, the NE configures an uplink grant for the PUSCH by the RRC signaling. For dynamic-grant PUSCH or Type2 configured-grant PUSCH, the NE transmits 506 a Downlink Control Information (DCI) indicating an uplink grant for the PUSCH transmission, where the NE indicates the associated DMRS port(s) for PT-RS port(s). Based on the received RRC signaling and/or DCI, UE 410 determines 508 the number of PT-RS ports, the associated DMRS port(s), and time-domain density for the PT-RS port(s). Then, UE 410 transmits 510 the PT-RS and PUSCH based on the determined PT-RS configuration. NE 420 determines 512 the number of PT-RS ports, the associated DMRS port(s), and time-domain density for the PT-RS port(s) in the same manner as UE 410.

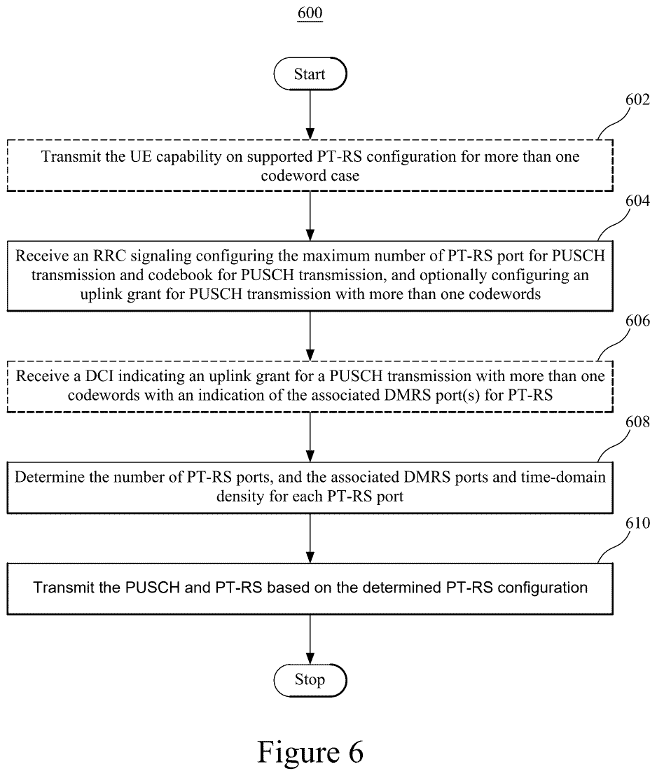

FIG. 6 illustrates UE's behavior for PT-RS transmission for PUSCH with more than one codewords according to an embodiment. Optionally (as suggested by the dashed-line box), UE transmits 602 UE's capability on supported PT-RS configuration for more than one codeword. The UE then receives 604 an RRC signaling configuring the maximum number of PT-RS ports for PUSCH transmission and codebook for PUSCH transmission and optionally configuring an uplink grant for PUSCH transmission with more than one codeword. The UE may also receive 606 a DCI indicating an uplink grant for a PUSCH transmission with more than one codeword and an indication of the associated DMRS port(s) for PT-RS (i.e., the one with best precoder). Further the UE determines 608 the number of PT-RS ports, the associated DMRS ports, and time-domain density for each PT-RS port.

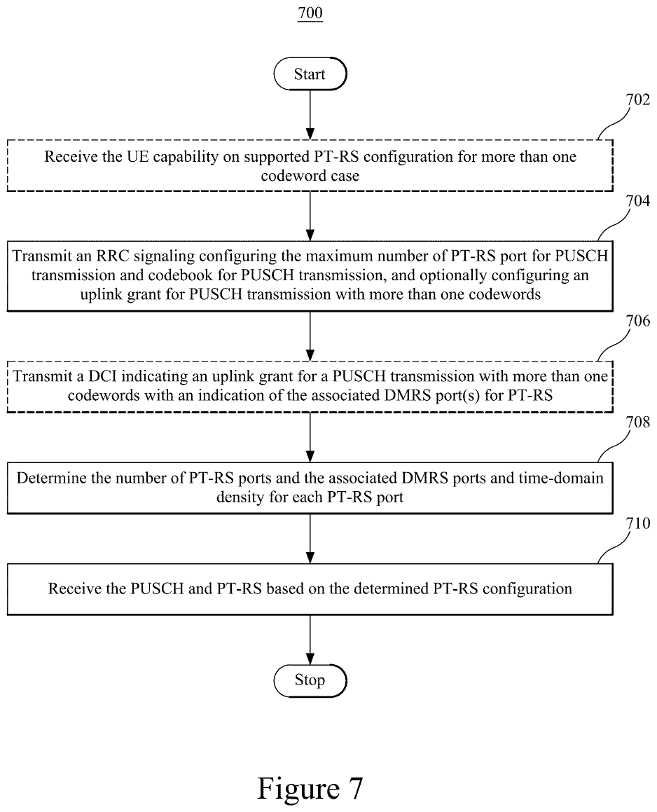

FIG. 7 illustrates NE's behavior for PT-RS reception for PUSCH with more than one codewords. Optionally (as suggested by the dashed-line box), the NE receives 702 the UE capability on supported PT-RS configuration for more than one codeword case. The NE then transmits 704 an RRC signaling configuring the maximum number of PT-RS ports for PUSCH transmission and codebook for PUSCH transmission, and optionally configuring an uplink grant for PUSCH transmission with more than one codeword. The NE may also transmit 706 a DCI indicating an uplink grant for a PUSCH transmission with more than one codeword and an indication of the associated DMRS port(s) for PT-RS. Further, the NE determines 708 the number of PT-RS ports and the associated DMRS ports and time-domain density for each PT-RS port. The NE then receives 710 the PUSCH and PT-RS based on the determined PT-RS configuration.

In the above-described signaling diagram, UE's and NE's behavior, a RRC signaling may indicate an RRC reconfiguration message from NE to UE, or a system information block (SIB), where the SIB can be an existing SIB (e.g., SIB1) or a new SIB (e.g., SIB J, where J is an integer above 21) transmitted by the NE.

In some embodiments, the UE and the NE determine (as in 608 and 708, respectively) the number of PT-RS ports for PUSCH transmission with more than four ports based on at least one of the following: the maximum number of PT-RS ports configured by RRC signaling, the precoder indicated by the uplink grant, and PUSCH ports that share a common PT-RS port.

The UE may report the UE capability indicating whether the UE supports more than one PT-RS port, e.g., two PT-RS ports, and the PUSCH ports that share a common PT-RS port. In some other implementations, the PUSCH ports that share a common PT-RS port are predefined. In one example, PUSCH port 1000, 1001, 1004 and 1005 may share one PT-RS port, and PUSCH port 1002, 1003, 1006 and 1007 may share another PT-RS port. In another example, PUSCH port 1000, 1002, 1004 and 1006 may share one PT-RS port, and PUSCH port 1001, 1003, 1005 and 1007 may share another PT-RS port.

In some embodiments, if the maximum number of PT-RS ports is 1, the UE can transmit the PT-RS from one port only; otherwise, the UE determines the number of PT-RS ports based on the indicated precoder. If the indicated precoder is a full-coherent precoder, (i.e., a precoder which requires antenna combination for all the PUSCH ports), the UE transmits the PUSCH from one port; otherwise, the UE determines the number of PT-RS ports based on the non-zero-power (NZP) PUSCH ports indicated by the precoder and the PUSCH ports that share a common PT-RS port. If all the NZP PUSCH ports share a common PT-RS port, the UE transmits the PT-RS from one port; otherwise, the UE transmits the PT-RS from more than one port.

In some other embodiments, the UE determines the number of PT-RS ports only based on the configured maximum number of PT-RS ports. If the maximum number of PT-RS port is X; the UE transmits the PT-RS from X ports.

In some other embodiments, for more than 4 ports transmission (e.g., 8 ports PUSCH or a PUSCH associated with an 8 ports SRS), only one port PT-RS is used. Thus, the NE may refrain from configuring that the maximum number of PT-RS ports is more than 1. Alternatively, the NE and UE may determine the number of PT-RS ports is 1 if the configured maximum number of PT-RS ports is more than 1 and the PUSCH for more than 4 ports transmission.

In some embodiments, if one of the codewords for PUSCH is disabled, the NE and/or UE determine the associated DMRS port for a PT-RS port based on the DMRS ports associated with the enabled (scheduled) codeword only. The NE and/or the UE may then determine the time domain density for the PT-RS based on the MCS for the enabled codeword.

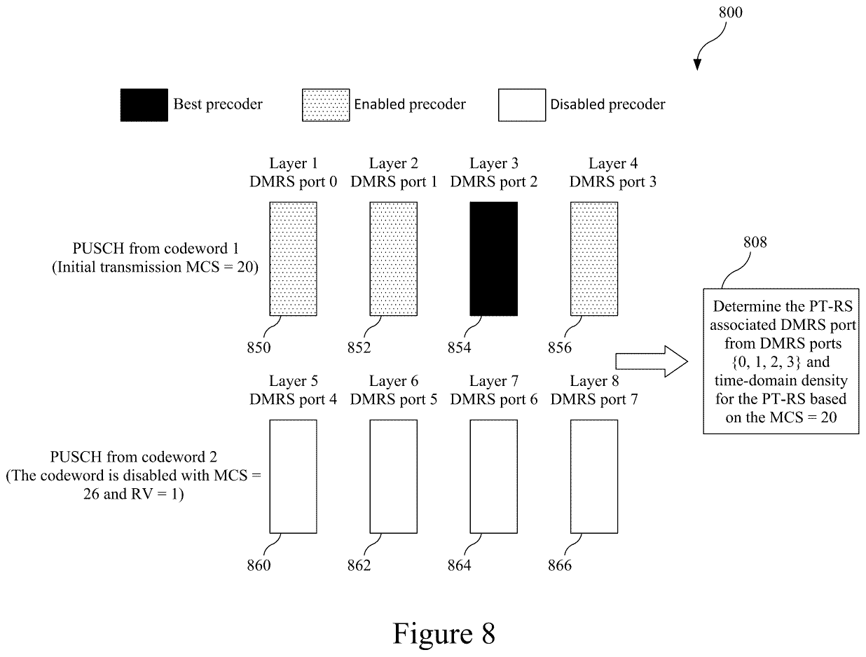

The associated DMRS port may be selected from the DMRS ports associated with the enabled codeword, where the DMRS ports associated with the enabled codeword are indicated in the scheduling DCI. FIG. 8 illustrates scenario 800 for the PT-RS and DMRS port association based on the enabled codeword only. Ports 850, 852, 854 and 856 pertain to the first codeword that is configured for an initial transmission with MCS=20. Ports 860, 862, 864 and 866 pertain to the second codeword that is disabled as indicated by MCS=26 and RV=1 (here RV stands for Redundancy Version). In this scenario, the NE and/or UE determine 808 the PT-RS associated DMRS port from DMRS ports 850-856, and the PT-RS time-domain density based on the MCS of the first codeword (MCS=20).

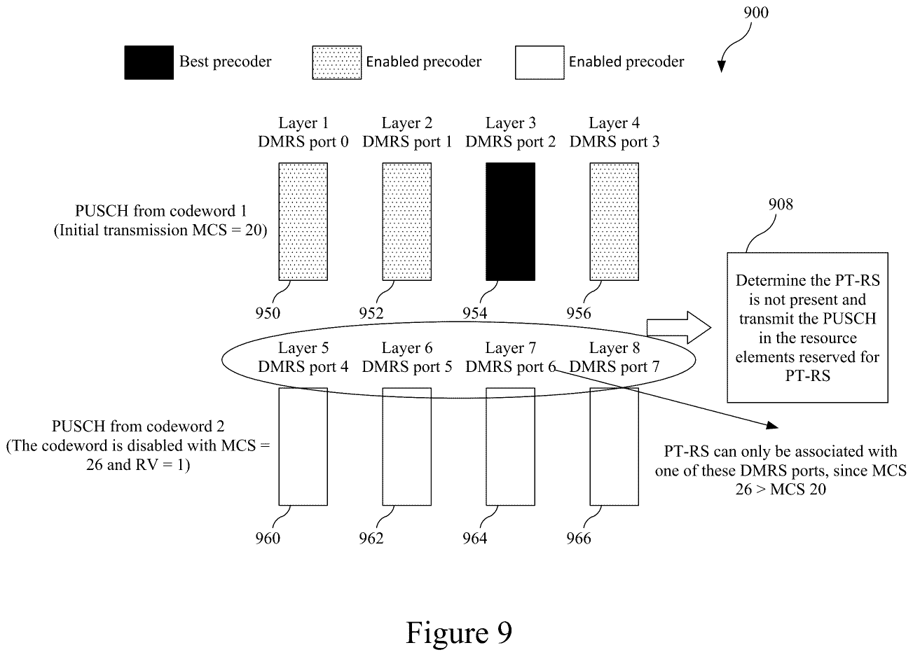

In other embodiments, if one of the codewords for a PUSCH is disabled and the NE and/or the UE determine the associated DMRS port for a PT-RS port is one of the DMRS ports associated with a disabled codeword, the NE and/or the UE determine the PT-RS is not present. Thus, the UE refrains from transmitting PT-RS for the PUSCH. The UE may transmit PUSCH data in the resource elements reserved/allocated for PT-RS. Alternatively, the UE may transmit the PT-RS with a default time domain density, e.g., L=1, where the default time domain density may be predefined, configured by the NE via RRC signaling or reported by the UE via the UE capability. FIG. 9 illustrates scenario 900 in which PT-RS is disabled when associated with a DMRS port corresponding to a disabled codeword. Scenario 900 has same setup as scenario 800 (with the second codeword disabled), but, here, the NE and/or UE determine 908 not to transmit PT-RS and use the resource elements reserved for PT-RS to transmit instead PUSCH data.

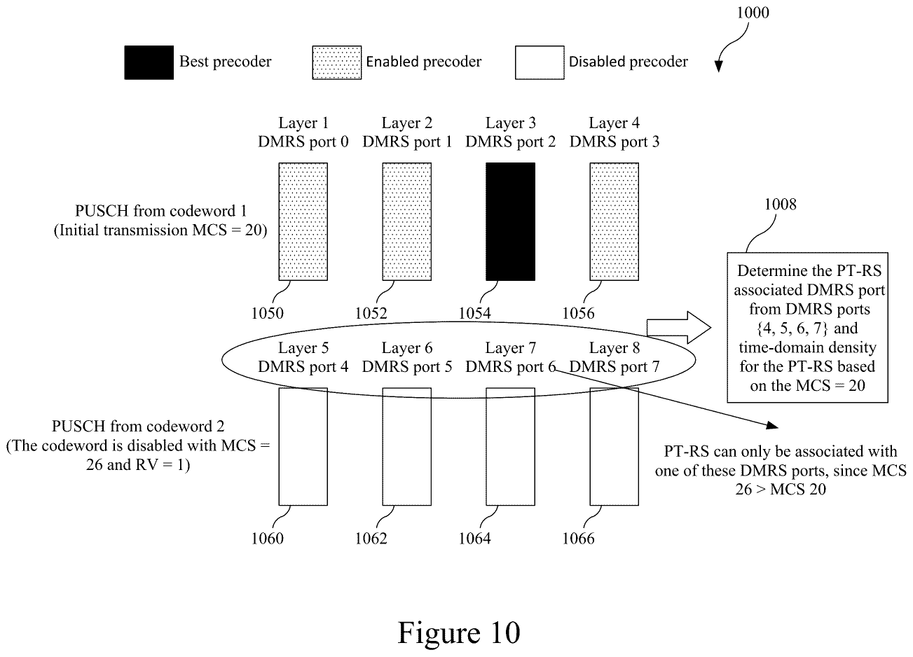

In yet other embodiments, if one of the codewords for PUSCH is disabled and the NE and/or the UE determine the associated DMRS port for a PT-RS port is one of the DMRS ports associated with a disabled codeword, the NE and/or the UE determine the PT-RS is still associated with the disabled codeword and determine the time domain density for the PT-RS based on the MCS for the enabled codeword. Alternatively, the NE and/or the UE still determine the time domain density for the PT-RS based on the MCS for the codeword corresponding to the associated DMRS port. FIG. 10 illustrates scenario 1000 related to determining the PT-RS time domain density based on the MCS from enabled codeword if PT-RS is associated with a DMRS port corresponding to a disabled codeword. Scenario 1000 has same setup as scenarios 800 and 900 (with the second codeword disabled), but, here, the NE and/or UE determine 1008 PT-RS associated port DMRS from DMRS ports 1060, 1062, 1064 and 1066 of the disabled codeword, and the time-domain density for the PT-RS based on the MCS of the first codeword (MCS=20).

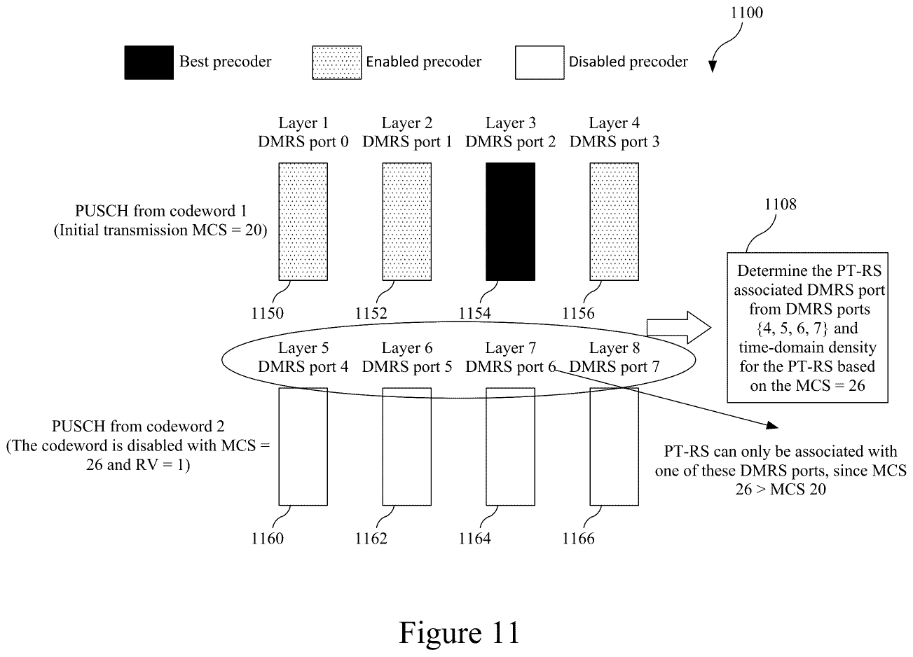

FIG. 11 illustrates scenario 1100 related to determining the PT-RS time domain density based on the MCS from the disabled codeword if the PT-RS is associated with a DMRS port corresponding to a disabled codeword. Scenario 1100 is also a scenario in which the second codeword is disabled, but, here, the NE and/or UE determine 1108 PT-RS associated port DMRS from DMRS ports 1160, 1162, 1164 and 1166 of the disabled codeword, and the time-domain density for the PT-RS based on the MCS of the second codeword (MCS=26).

In other embodiments, the UE may report the UE capability indicating whether it supports transmitting a PT-RS associated with a DMRS port corresponding to a disabled codeword. If the UE does not support transmitting a PT-RS associated with a DMRS port corresponding to a disabled codeword, the UE refrains from transmitting PT-RS when the codeword is disabled. If the UE receives an indication/configuration from the NE to transmit a PT-RS associated with a DMRS port corresponding to a disabled codeword, the UE may then ignore or discard the indication/configuration. Alternatively, if the UE does not support transmitting a PT-RS associated with a DMRS port corresponding to a disabled codeword, the NE may refrain from indicating a PT-RS port associated with a DMRS port corresponding to a disabled codeword.

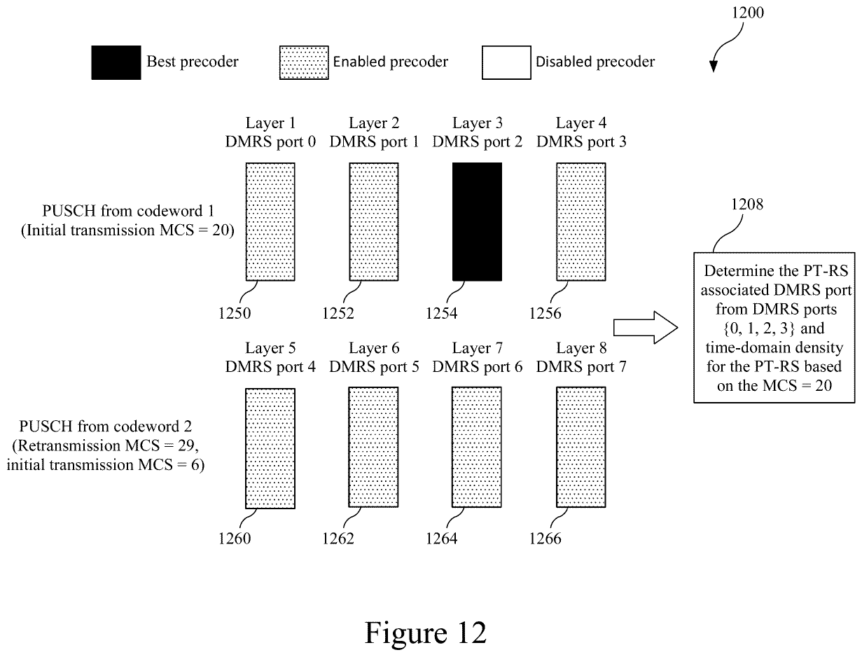

In some embodiments, if one of MCS indicated in a scheduling DCI is a reserved MCS, the NE and/or the UE determine the associated DMRS port for a PT-RS port and the time domain density for the PT-RS based on a previously indicated MCS for the initial transmission of the codeword with reserved MCS in the scheduling DCI, and other indicated MCS(s) for transmission(s) in the scheduling DCI. For initial transmission, the network entity refrains from indicating the reserved MCS. FIG. 12 illustrates scenario related to determining PT-RS time domain density and PT-RS associated DMRS port based on the MCS for initial transmission when one of the indicated MCS is reserved MCS. In the scenario 1200 illustrated in FIG. 12, instead of retransmission MCS of codeword 2, initial transmission MCS of codeword 2 is used to compare with initial transmission MCS of codeword 1. Unlike in scenarios 800, 900, 1000 and 1100, in this scenario, the second codeword is not disabled instead being a retransmission as indicated by MCS=29 following an initial transmission with MCS=6. In this scenario, the NE and/or UE determine 1208 the PT-RS associated DMRS port from DMRS ports 1250-1256, and the PT-RS time-domain density based on the MCS of the first codeword (MCS=20).

In other embodiments, if one of indicated MCS is reserved MCS, the NE and/or the UE determine the associated DMRS port for a PT-RS port and the time domain density for the PT-RS based on a nominal MCS and other indicated MCS(s) for current transmission. One example of selecting/determining nominal MCS is based on the calculated average spectrum efficiency (SE) for each layer for the corresponding codeword, and the MCS table. The largest MCS in the MCS table corresponding to a smaller SE than the calculated SE is selected as nominal MCS. Alternatively, the smallest MCS in the MCS table corresponding to a higher SE than the calculated SE is selected. The SE can be calculated as follows:

$$S E = \frac{B}{{N}_{L} ( {N}_{R E} - {N}_{o} )}$$

where B indicates the transport block (TB) size for the codeword; N_{L} is the number of layers for the codeword; N_{RE} is the number of resource elements scheduled for the PUSCH; Nₒ is the overhead for DMRS and other signals.

In some other implementations, the network and UE can determine the associated DMRS ports based on the SE from all the MCS. In some implementations, for the indicated MCS other than the reserved MCS, the UE selects the SE based on the MCS table. In some other implementations, the UE calculates the actual SE based on the equation above.

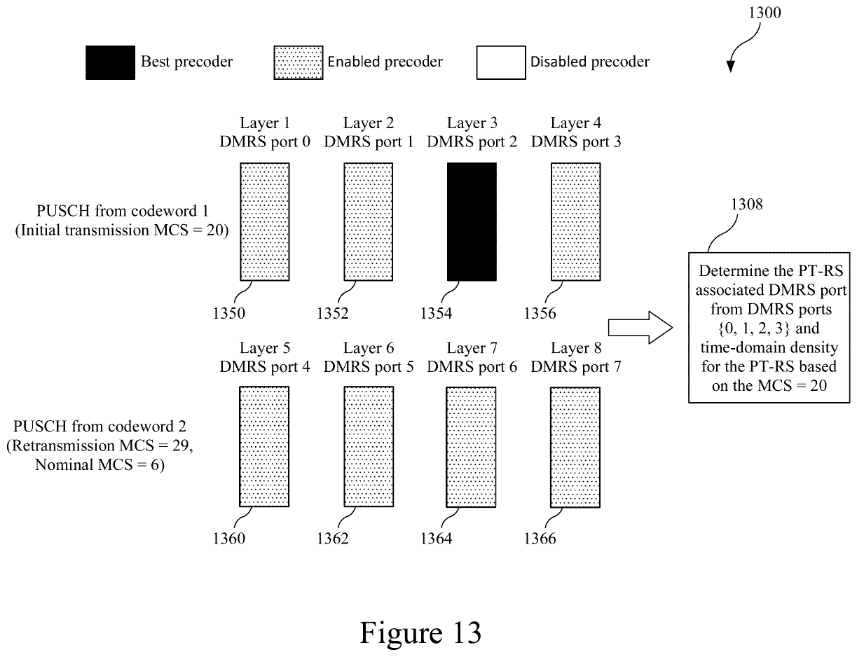

FIG. 13 illustrates scenario 1300 in which PT-RS associated DMRS port and the time domain density for a PT-RS port are based on a nominal MCS when one of the indicated MCS is reserved MCS. Although starting from the same setup as in FIG. 12, in this scenario instead of using the retransmission MCS of the second codeword, a nominal MCS is used to compare with initial transmission MCS of the first codeword. That is, the NE and/or the UE determine 1308 the PT-RS associated DMRS port from ports 1350, 1352, 1354 and 1356, and the time-domain density for the PT-RS based on the first codeword's MCS (MCS=20).

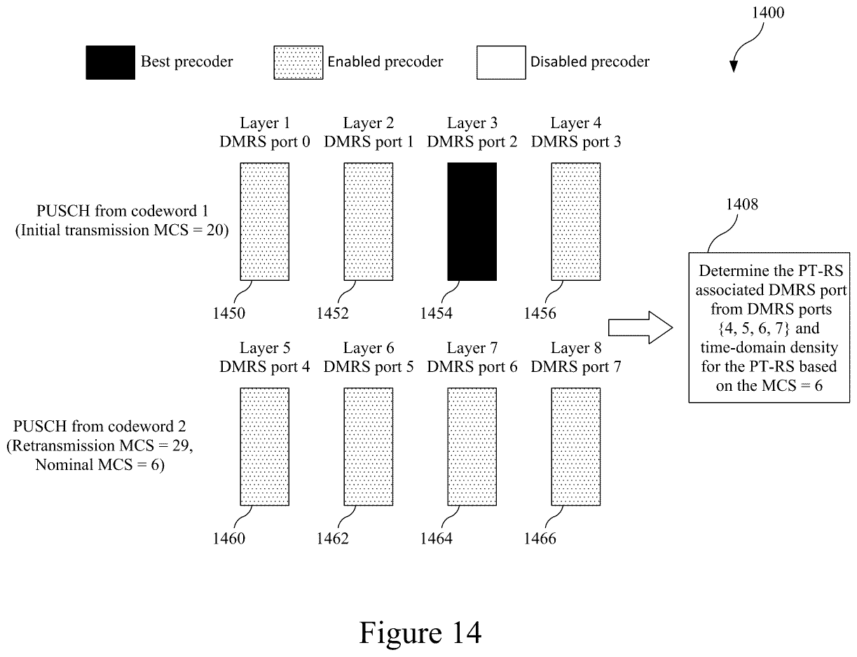

In other embodiments, if one of indicated MCS is reserved MCS, the NE and/or UE determine the PT-RS associated DMRS port based on the codeword with reserved MCS and determine the time domain density for a PT-RS port based on the MCS indicated for the same codeword in initial transmission. For initial transmission, the network entity refrains from indicating the reserved MCS. FIG. 14 illustrates scenario 1400 in which PT-RS time domain density is determined based on the MCS for initial transmission when one of the indicated MCS is reserved MCS. Scenario 1400 has the same setup and MCS values as scenarios 1200 and 1300. Here, the NE and the UE determine 1408 the PT-RS associated DMRS port from ports 1450, 1452, 1454 and 1456, and the time-domain density for the PT-RS based on the initial MCS (MCS=20).

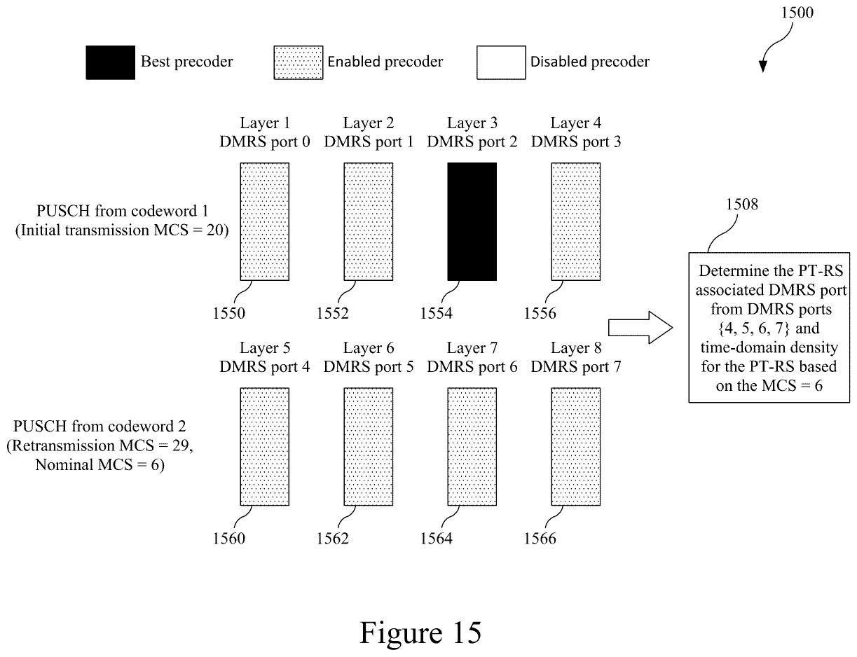

In yet other embodiments, if one of indicated MCS is reserved MCS, the NE and/or the UE determine the associated DMRS port based on the codeword with reserved MCS and determine the time domain density for a PT-RS port based on the nominal MCS if the indicated MCS for the associated DMRS port is reserved MCS. FIG. 15 illustrates scenario 1500 for determining the PT-RS time domain density based on the nominal MCS when the MCS for the codeword corresponding to PT-RS associated DMRS port is a reserved MCS. Scenario 1500 has similar setup and MCS values as scenarios 1200, 1300 and 1400, but the second codeword, which is still a retransmission, has a nominal transmission's MCS=6. Here, the NE and the UE determine 1508 the PT-RS associated DMRS port from ports 1550, 1552, 1554 and 1556, and the time-domain density for the PT-RS based on the nominal MCS (MCS=6).

In some embodiments, if one of indicated MCS is a reserved MCS, the NE and/or UE determine the PT-RS is not present. Thus, if the MCS for the codeword corresponding to PT-RS associated DMRS port is a reserved MCS, the UE refrains from transmitting the PT-RS for the PUSCH. The UE may transmit PUSCH data in the resource elements reserved/allocated for the PT-RS. Alternatively, if one of indicated MCS is a reserved MCS, the NE and/or the UE determine the PT-RS is based on a default time-domain density, where the default time domain density may be predefined or configured by the network entity via RRC signaling or reported by the UE via UE capability.

In other embodiments, the UE reports the UE capability indicating whether the UE supports to transmit a PT-RS associated with a DMRS port corresponding to a codeword with a reserved MCS. If the UE does not support transmitting the PT-RS using a port corresponding to a codeword with a reserved MCS, the UE refrains from transmitting PT-RS. A UE receiving an indication/configuration from the NE to transmit a PT-RS associated with a DMRS port corresponding to a codeword with reserved MCS, ignores or discards the indication/configuration. Alternatively, if the UE does not support transmitting the PT-RS using a port corresponding to a codeword with a reserved MCS, the NE refrains from indicating reserved MCS when PT-RS is present or configured in an active bandwidth part.

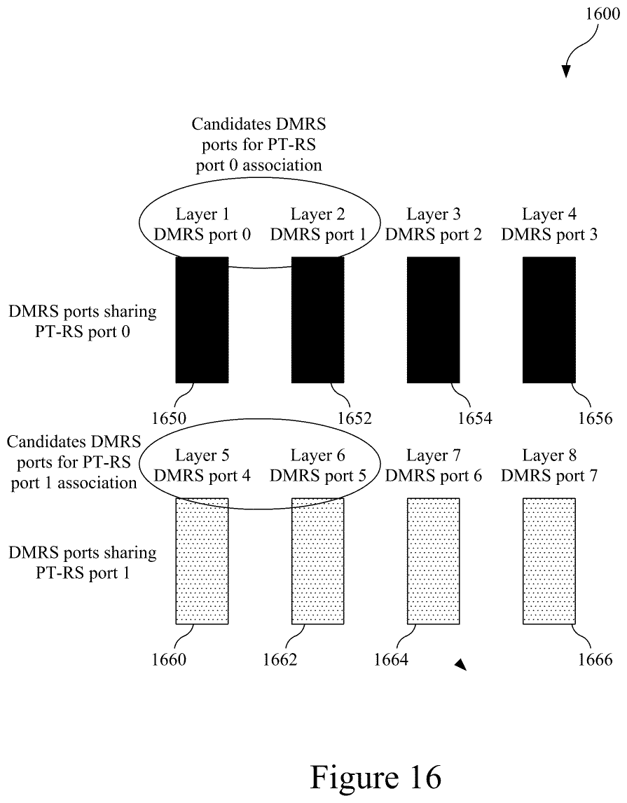

In some embodiments, if the maximum number of PT-RS ports is above 1 (e.g., 2), the bit-width of a DCI field for indicating the PT-RS and DMRS port association is based on the bit-width for the 1 port PT-RS case. Then for 2 port PT-RS, the network entity can indicate one of a subset of DMRS ports that share the first and second PT-RS port, respectively. For example, for 1 port PT-RS, 2 bits are reserved/used for PT-RS and DMRS port association. The NE can indicate one of the four DMRS ports associated with one codeword. For 2 port PT-RS, the NE may indicate one of 2 DMRS ports from the 4 DMRS ports that share the first PT-RS port via the first bit, and another one of 2 DMRS ports from the 4 DMRS ports that share the first PT-RS port via the second bit. FIG. 16 illustrates scenario 1600 for indicating PT-RS associated DMRS port with limited overhead in DCI. In this scenario DMRS ports 1650 and 1652, as well as, 1660 and 1662 are candidate DMRS ports for PT-RS port 0 and PT-RS port 1, respectively.

In some embodiments, the subset of DMRS ports may be predefined, (e.g., the first K DMRS ports among the DMRS ports that share a common PT-RS port). In some other embodiments, the subset of DMRS ports may be determined based on the scheduling MCS for the DMRS ports associated with the codeword, (e.g., the K DMRS ports are the first K DMRS ports associated with the codeword with higher MCS). If the MCS of the codewords are the same, the first K DMRS ports are selected. In some other embodiments, the NE configures the subset of DMRS ports via RRC signaling or MAC CE. For example, the network entity configures whether the subset of DMRS ports is the first two DMRS ports or the last two DMRS ports, or any combination of two DMRS ports. In some other embodiments, the NE indicates the subset of DMRS ports via DCI. For example, in the DCI, the network entity may indicate whether the candidate associated DMRS ports is the first two DMRS ports or the last two DMRS ports or any combination of two DMRS ports by some reserved field, e.g., DMRS antenna ports.

In some embodiments, if the maximum number of PT-RS ports is larger than 1 (e.g., 2), the bit-width of a DCI field for indicating the PT-RS and DMRS port association is based on the bit-width for the number of PT-RS ports with highest bit-width, e.g., 2 port PT-RS case, e.g., 4 bits. Then for 2 port PT-RS, the network entity can indicate one of DMRS ports that share a common PT-RS port.

In some embodiments, for 1 port PT-RS, a subset of bits (e.g., the first two bits) are used for PT-RS and DMRS port association, which indicates one of the DMRS ports is associated with a codeword, and the other two bits are reserved. In some other embodiments, for one PT-RS port, a subset of bits, e.g., the first three bits, are used for PT-RS and DMRS port association, which indicates one of all the DMRS ports, and the remaining one bit is reserved. In some other implementations, for 1 port PT-RS, a subset of bits, e.g., the first 2 bits, may be used for PT-RS and DMRS port association, which indicates one of the DMRS ports associated with a codeword, and another subset of bits, e.g., 1 bit, may be used to indicate the codeword index for the candidate DMRS ports, and other bits, e.g., 1 bit, are reserved.

In other embodiments, the bit-width of a DCI field for indicating the PT-RS and DMRS port association is determined based on whether it's a one port PT-RS case or a two port PT-RS case. For example, if it's a one port PT-RS case, the bit-width of the DCI field for indicating the PT-RS and DMRS port association is 2, and if it's a two port PT-RS case, the bit-width of the DCI field for indicating the PT-RS and DMRS port association is 4.

In yet other embodiments, the amount of DCI field(s) for indicating the PT-RS and DMRS port association in a scheduling DCI is determined based on whether it's one port PT-RS case or a two port PT-RS case. For example, if it's a one port PT-RS case, a scheduling DCI carries one DCI field for indicating the PT-RS and DMRS port association with a 2 bit-width; if it's two port PT-RS case, a scheduling DCI caries two DCI fields, each of which indicates the PT-RS and DMRS port association and be with a 2-bit-width.

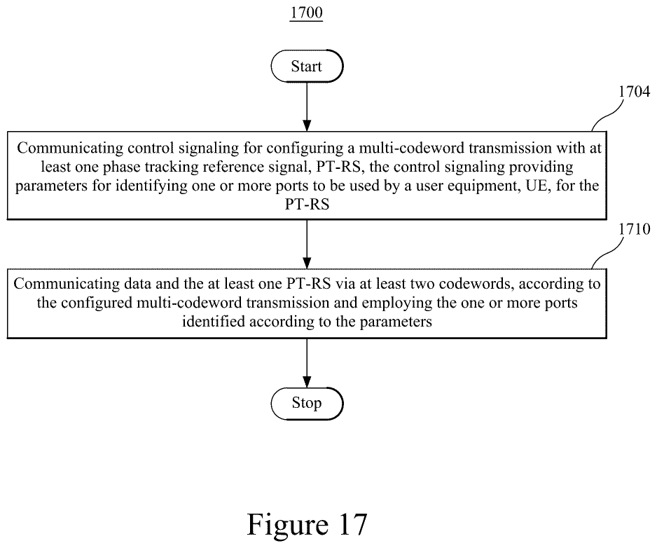

FIG. 17 is a flowchart of a method 1700 performed by a wireless device (NE or UE) engaged in a multi-codeword transmission including PT-RS. Method 1700 includes communicating 1704 control signaling for configuring a multi-codeword transmission of at least one phase tracking reference signal, PT-RS, the control signaling providing parameters for identifying one or more ports to be used by a user equipment, UE, for the PT-RS. Method 1700 further includes communicating 1710 data and the at least one PT-RS via at least two codewords, according to the configured multi-codeword transmission and employing the one or more ports identified according to the parameters.

If the wireless device performing method 1700 is the UE, the communicating the control signaling includes receiving the control signaling, and the communicating the data and the at least one PT-RS includes transmitting the data and the at least one PT-RS via the at least two codewords. If the wireless device is a network device, the communicating the control signaling includes transmitting the control signaling, and the communicating the data and the at least one PT-RS includes receiving the data and the at least one PT-RS.

Method 1700 may further include determining a PT-RS number of ports to be used by the UE for the at least one PT-RS based on at least one of a maximum number of PT-RS ports included in the parameters, a precoder indicated by an uplink grant for the multi-codeword transmission, or an indication of data ports sharing a common PT-RS. The PT-RS number of ports to be used by the UE for the at least one PT-RS may be equal to the maximum number of PT-RS ports. If the maximum number of PT-RS is larger than 1, this determining may include selecting the PT-RS number of ports based on at least one of the precoder or the indication of the data ports sharing the common PT-RS. If the maximum number of PT-RS ports is larger than 1, the parameters may include a subset indication for a port combination candidate for the one or more ports to be used by the UE for transmitting the PT-RS.

Method 1700 may also include identifying the one or more ports to be used by the UE for the PT-RS among ports used alternatively (i.e., in other symbols) to transmit demodulation reference signals, DMRS, the PT-RS being transmitted with a precoder that yields most energy according to the parameters. Alternatively or additionally, method 1700 may further include determining a time domain density for the transmitting the PT-RS based on a modulation and coding scheme, MCS, associated with a codeword among the at least two codewords, usable for transmitting the at least one PT-RS, wherein the codeword is associated with a highest MCS among the at least two codewords, if the highest MCS is non-reserved MCS and the codeword is enabled. If the codeword is disabled, the UE may: (1) refrain from transmitting the at least one PT-RS, (2) the one or more ports to be used by the UE for the PT-RS pertain to the disabled codeword, and the time domain density has a default value, or (3) the one or more ports to be used by the UE for the PT-RS pertain to the disabled codeword, and the determining of the time domain density is based on the MCS associated with an enabled codeword among the at least two codewords. If the highest MCS is a reserved MCS, the determining of the time domain density and the identifying the one or more ports to be used by the UE for the PT-RS may be based on another MCS value calculated or configured.

Method 1700 may also include communicating a UE capability for uplink PT-RS included in the multi-word transmission, the controlling signaling being then based on a UE capability for uplink PT-RS included in the multi-codeword transmission.

The embodiment descriptions in this section refer to the accompanying drawings. The same reference numbers in different drawings identify the same or similar elements. The detailed descriptions do preclude other embodiments within the scope of the appended claims. The embodiments are not limited to the described configurations but may be extended to other arrangements.

Reference throughout this section to “one embodiment” or “an embodiment” means that a particular feature, structure, or characteristic described in connection with an embodiment is included in at least one embodiment. Thus, the appearances of the phrases “in one embodiment” or “in an embodiment” in various places throughout the specification are not necessarily all referring to the same embodiment. Further, the particular features, structures or characteristics may be combined in any suitable manner in one or more embodiments.

Numerical adjectives “first”, “second”, and “third” do not imply any order (are not ordinals) but are markers to distinguish separate instances of similar elements. References to the singular (e.g., “a” or “an”, “the”) should include the plural unless clearly indicated otherwise.

Although the features and elements of the present embodiments are described in the embodiments in particular combinations, each feature or element can be used alone without the other features and elements of the embodiments or in various combinations with or without other features and elements disclosed herein. The methods or flowcharts may be implemented in a computer program, software or firmware tangibly embodied in a computer-readable storage medium for execution by a specifically programmed computer or processor.

1-17. (canceled)

18. A method performed by a user equipment (UE), the method comprising:
receiving control signaling for configuring a multi-codeword data transmission with at least one phase tracking reference signal (PT-RS), the control signaling providing parameters for identifying one or more ports to be used by the UE for the PT-RS;
transmitting data and the at least one PT-RS via at least two codewords, according to the configured multi-codeword transmission and employing the one or more ports identified according to the parameters; and
determining a time domain density for the transmitting of the PT-RS based on a modulation and coding scheme (MCS), associated with a codeword among the at least two codewords usable for transmitting the at least one PT-RS, wherein the codeword is associated with a highest MCS among the at least two codewords, if the codeword is enabled.

19. The method of claim 18, wherein the data is transmitted on a physical uplink shared channel, PUSCH.

20. The method of any of claim 18, further comprising:
determining a PT-RS number of ports to be used by the UE for the at least one PT-RS based on at least one of a maximum number of PT-RS ports included in the parameters, a precoder indicated by an uplink grant for the multi-codeword transmission, or an indication of data ports sharing a common PT-RS.

21. The method of claim 20, wherein the PT-RS number of ports to be used by the UE for the at least one PT-RS is equal to the maximum number of PT-RS ports.

22. The method of claim 20, wherein, if the maximum number of PT-RS ports is larger than 1, the determining includes selecting the PT-RS number of ports based on at least one of the precoder or the indication of the data ports sharing the common PT-RS.

23. The method of claim 20, wherein if the maximum number of PT-RS ports is larger than 1, the parameters include a subset indication for a port combination candidate for the one or more ports to be used by the UE for transmitting the PT-RS.

24. The method of claim 18, further comprising:
identifying the one or more ports to be used by the UE for the PT-RS among ports used alternatively to transmit demodulation reference signals, DMRS, the PT-RS being transmitted with a precoder used for the DMRS.

25. The method of claim 18, wherein if the codeword is disabled, the UE refrains from transmitting the at least one PT-RS.

26. The method of claim 18, wherein if the codeword is disabled, the one or more ports to be used by the UE for the PT-RS pertain to the disabled codeword, and the time domain density has a default value.

27. The method of claim 18, wherein if the codeword is disabled, the one or more ports to be used by the UE for the PT-RS pertain to the disabled codeword, and the determining of the time domain density is based on the MCS associated with an enabled codeword among the at least two codewords.

28. The method of claim 18, wherein if the highest MCS is a reserved MCS, the determining of the time domain density and the identifying the one or more ports to be used by the UE for the PT-RS is based on a prior MCS of the codeword.

29. The method of claim 18, wherein if the highest MCS is a reserved MCS, the determining of the time domain density and the identifying the one or more ports to be used by the UE for the PT-RS is based on another MCS value calculated or configured.

30. The method of claim 18, further comprising:
transmitting a UE capability for uplink PT-RS included in the multi-codeword transmission, wherein the controlling signaling is based on a UE capability for uplink PT-RS included in the multi-codeword transmission.

31. A user equipment (UE) comprising:
a transceiver; and
a processor connected to the transceiver and configured to:
receive control signaling for configuring a multi-codeword data transmission with at least one phase tracking reference signal (PT-RS), the control signaling providing parameters for identifying one or more ports to be used by the UE for the PT-RS,
transmit data and the at least one PT-RS via at least two codewords, according to the configured multi-codeword transmission and employing the one or more ports identified according to the parameters; and
determine a time domain density for the transmitting of the PT-RS based on a modulation and coding scheme (MCS), associated with a codeword among the at least two codewords usable for transmitting the at least one PT-RS, wherein the codeword is associated with a highest MCS among the at least two codewords, if the codeword is enabled.

32. The UE of claim 31, wherein the processor is further configured to determine a PT-RS number of ports to be used by the UE for the at least one PT-RS based on at least one of a maximum number of PT-RS ports included in the parameters, a precoder indicated by an uplink grant for the multi-codeword transmission, or an indication of data ports sharing a common PT-RS.

33. The UE of claim 31, wherein the processor is further configured to identify the one or more ports to be used by the UE for the PT-RS among ports used alternatively to transmit demodulation reference signals, DMRS, the PT-RS being transmitted with a precoder used for the DMRS.

34. A method performed by a network device, the method comprising:
transmitting control signaling for configuring a multi-codeword data transmission with at least one phase tracking reference signal (PT-RS), the control signaling providing parameters for identifying one or more ports to be used by a user equipment (UE), for the PT-RS;
receiving data and the at least one PT-RS via at least two codewords, according to the configured multi-codeword transmission and employing the one or more ports identified according to the parameters; and
determining a time domain density for the receiving of the PT-RS based on a modulation and coding scheme (MCS) associated with a codeword among the at least two codewords usable for the receiving of at least one PT-RS, wherein the codeword is associated with a highest MCS among the at least two codewords, if the codeword is enabled.

35. The method of claim 34, wherein if the highest MCS is a reserved MCS, the determining of the time domain density and the identifying the one or more ports to be used by the UE for the PT-RS is based on a prior MCS of the codeword.

36. The method of claim 34, further comprising:
receiving a UE capability for uplink PT-RS included in the multi-codeword transmission, wherein the controlling signaling is based on the UE capability for uplink PT-RS included in the multi-codeword transmission.

37. A network device comprising:
a transceiver; and
a processor connected to the transceiver and configured to:
transmit control signaling for configuring a multi-codeword data transmission with at least one phase tracking reference signal (PT-RS), the control signaling providing parameters for identifying one or more ports to be used by a user equipment (UE), for the PT-RS;
receive data and the at least one PT-RS via at least two codewords, according to the configured multi-codeword transmission and employing the one or more ports identified according to the parameters; and
determine a time domain density for the receiving of the PT-RS based on a modulation and coding scheme (MCS) associated with a codeword among the at least two codewords usable for the receiving of at least one PT-RS, wherein the codeword is associated with a highest MCS among the at least two codewords, if the codeword is enabled.
